(19) United States
(12) Patent Application Publication
(10) Pub. No.: US 2010/0000745 A1
(43) Pub. Date: Jan. 7, 2010

(54) Integrated water supply system for multi-floor buildings

(76) Inventor: Kevin Mark Monk, Queensland (AU)

Correspondence Address: AMSTER, ROTHSTEIN & EBENSTEIN LLP, 90 PARK AVENUE, NEW YORK, NY, 10016, US

(21) Appl. No.: 11/597,842

(22) PCT Filed: Apr. 12, 2005
(86) PCT No.: PCT/IB05/01695

§ 371 Date: Dec. 17, 2008

(30) Foreign Application Priority Data
May 28, 2004 (AU) 2004100402

(51) Int. Cl. A62C 35/00; E03C 1/02

(52) U.S. Cl. 169/16; 137/357

(57) ABSTRACT

The water supply system integrates fire and domestic supplies for a multi-floor building. A vertical ring main (11) supplies water to a network of pipes (50) on each floor. Each network includes multiple horizontal ring mains that supply water to both the sprinklers (S) and domestic fixtures (F) for a particular dwelling. Each floor also has a fire hydrant connected (16) to the vertical ring main. A single pump can be used for each vertical ring main.

### BACKGROUND TO THE INVENTION

Conventional water services for multi-floor buildings provide water to each floor through two or more separate piping systems for fire and domestic use. Each system has a separate pump that is usually housed in the basement of the building.

Fire protection is typically provided through a system that pumps water to sprinkler heads and hydrant valves throughout the building. Separate sprinkler and hydrant systems are generally provided. The fire water service is rarely used but should be tested regularly to ensure correct operation in an emergency. In practice however, the tests are often neglected and the respective pumps may not be operated for intervals of several years or more.

The domestic service is typically provided through a system that pumps water to plumbing fixtures through a network of pipes on each floor. The domestic system is generally provided separate from the fire system, requiring multiple pipes to each floor and multiple pumps.

### SUMMARY OF THE INVENTION

It is an object of this invention to provide an integrated system that combines fire and domestic water services for multi-floor buildings, or at least to provide a useful alternative to existing systems.

The invention may be said to consist in a water supply system for a multi-floor building, including: a vertical pipe that supplies water to two or more floors in the building, a network of pipes on each floor connected to the vertical pipe, and a hydrant on each floor connected to the vertical pipe, wherein the network on each floor includes at least one horizontal ring main having one or more fire sprinklers and one or more vertical branches each connected from the ring main to one or more domestic plumbing fixtures.

Preferably the vertical pipe is part of a vertical ring main that supplies water to multiple floors, and the network on each floor includes multiple horizontal ring mains that supply water to respective dwellings on the floor.

### LIST OF FIGURES

Preferred embodiments of the invention will be described with respect to the accompanying drawings, of which:

FIG. 1 shows a water service according to an exemplary embodiment of the invention in a multi-floor building;

FIG. 2 shows a simplified schematic of a water-supply sub-system according to an exemplary embodiment of the invention;

FIG. 3 is a plan view of a network of water pipes on a single floor in the building of FIG. 1;

FIG. 4 is a vertical cross-sectional view of part of a network according to an exemplary embodiment of the invention on a single floor of the building in FIG. 1; and

FIG. 5 shows a sprinkler component as part of the water-supply network according to an exemplary embodiment of the invention.

### DESCRIPTION OF FIGURES

Referring to the drawings it will be appreciated that the invention may be implemented in various ways for a range of different buildings, and that this description is given by way of example only.

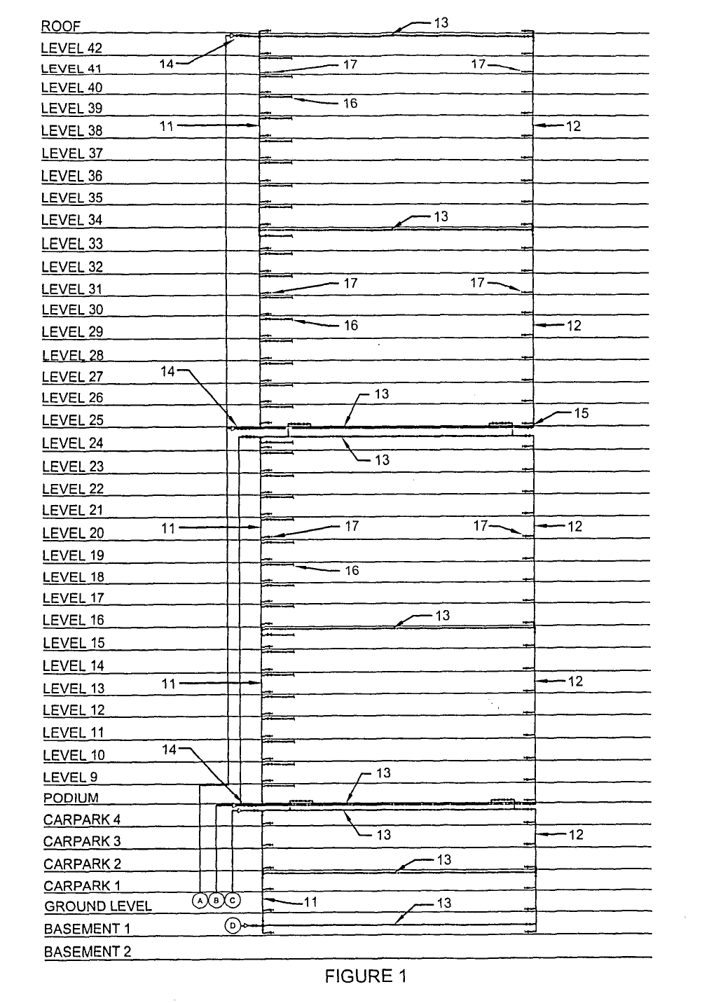

FIG. 1 shows a water service according to an exemplary embodiment of the invention for a high rise building having 42 floors including car park and basement levels. Three, sub-systems A, B, C/D provide integrated water services to floors 25-42, 8-24 and the lower floors respectively, which are supplied as separate zones to ensure acceptable pressure throughout the height of the building. Each sub-system is a vertical ring main supplied by a separate pump (not shown) and includes two vertical branches 11, 12 and two or more horizontal branches 13. The vertical pipes 11, 12 are typically located in or near a respective stairwell or hydraulic duct, for at least part of their height.

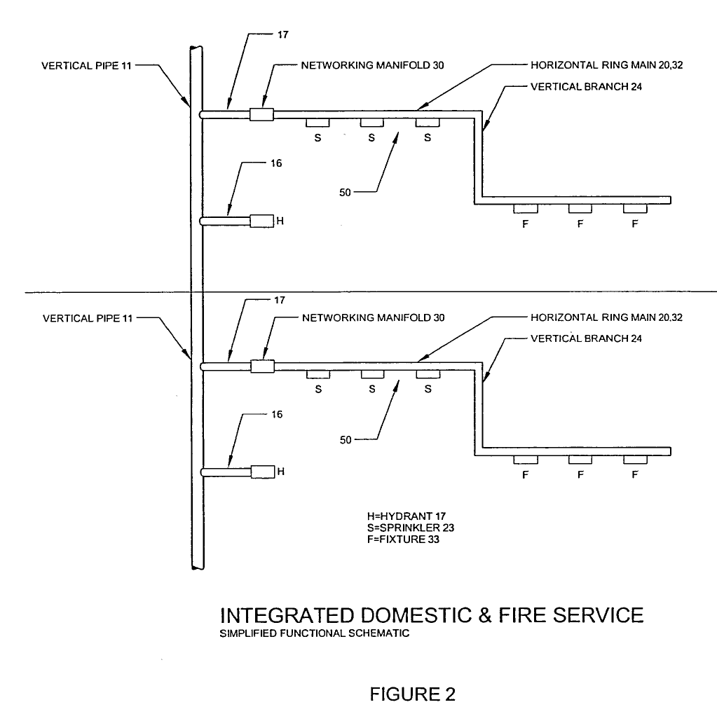

Each of the sub-systems A, B, C/D in FIG. 1 includes at least one main ring valve 14 and one or more monitored isolating valves 15. Other detailed features of these sub-systems will be appreciated by a skilled person. FIG. 2 shows a simplified schematic of a water-supply subsystem according to an exemplary embodiment of the invention. As shown in FIG. 2, each floor within a vertical ring main is provided with an outlet 16 to at least one fire hydrant H, and an outlet 17 to a network 50 that supplies sprinkler water to sprinklers S and domestic water to fixtures F throughout the floor. The network 50 typically includes a manifold 30 that supplies water to a separate ring main 20, 32 for each dwelling on the floor, although other arrangements are also possible, such as the manifold 30 being part of the main vertical pipe 11, for example. Vertical branches 24 connect the ring main 20, 32 to the fixtures F. Although one vertical branch 24 is shown in FIG. 2, any number of vertical branches 24 may be used to deliver water to one or more fixtures F in a dwelling unit.

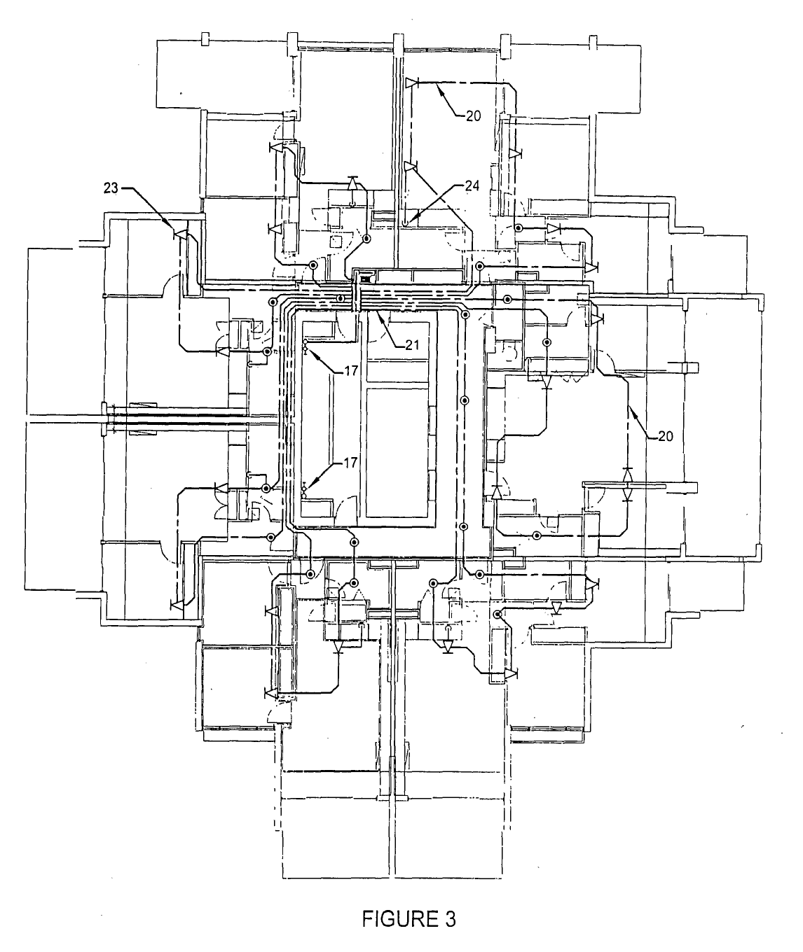

FIG. 3 shows a typical network of water pipes on a floor in the building of FIG. 1 as a plan view. The network includes separate horizontal ring mains 20, each supplying water to a respective dwelling, such as a relatively small apartment. In this example, the network includes a manifold 21 which is a central point for each of the ring mains 20. These ring mains 20 are sub-networks of water pipes, most or all of which supply water to both sprinklers S and domestic fixtures F in the particular dwelling. Each ring main 20 is preferably a simple horizontal loop, formed in the ceiling of the dwelling, with sprinklers S connected in series and vertical branches 24 for supply of water to the domestic fixtures F in the dwelling.

Ring main 20 in FIG. 3 relates to a relatively small apartment for example. It includes three sprinkler heads 23 and a single branch 24 for domestic fixtures. Two outlets 17 for hydrants are shown on the floor. Many variations are possible, such as more than one ring main supplying water to a dwelling, or a ring main having a structure more complex than a simple loop, although these are relatively uncommon. Fire hose reels are also normally provided in addition to the hydrant, and may be connected to the main pipe 11 or suitably in the network on a particular floor.

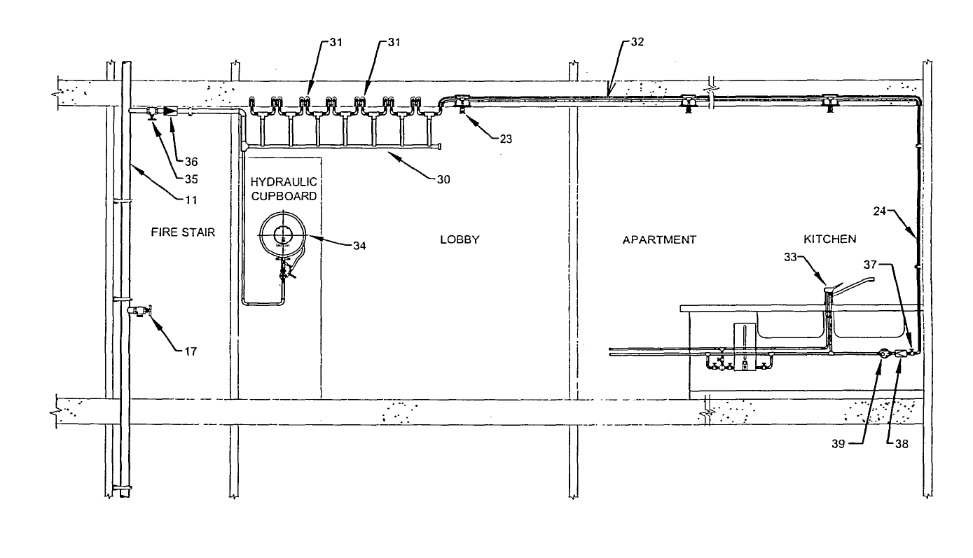

FIG. 4 shows part of a ring main in FIG. 3 as a vertical cross section through part of a floor. A vertical main pipe 11 supplies water to the floor. A manifold 30 supplies water from the vertical pipe 11 to multiple ring mains 32 on the floor, each being a loop having two end points 31 in this example. A portion 32 of one horizontal ring main is shown in the ceiling of an apartment, including three sprinklers 23 and vertical branch 24. A domestic fixture is supplied by the branch, in this case a tap 33 over a pair of sinks. A hydrant 17 on the landing of the floor is supplied from the main pipe 11, while a hose reel 34 is supplied from the manifold.

The network in FIG. 4 includes additional features, such as an isolating valve 35 and a flow monitor 36, while the branch supplying the domestic fixtures includes an isolating valve 37, a pressure limiting valve 38 and a meter 39 for the particular apartment. The flow monitor 36 may be triggered by an increased water flow to transmit an alarm to a central station, indicating that the sprinklers have been activated. Other components may be included or omitted as required to suit the local environment.

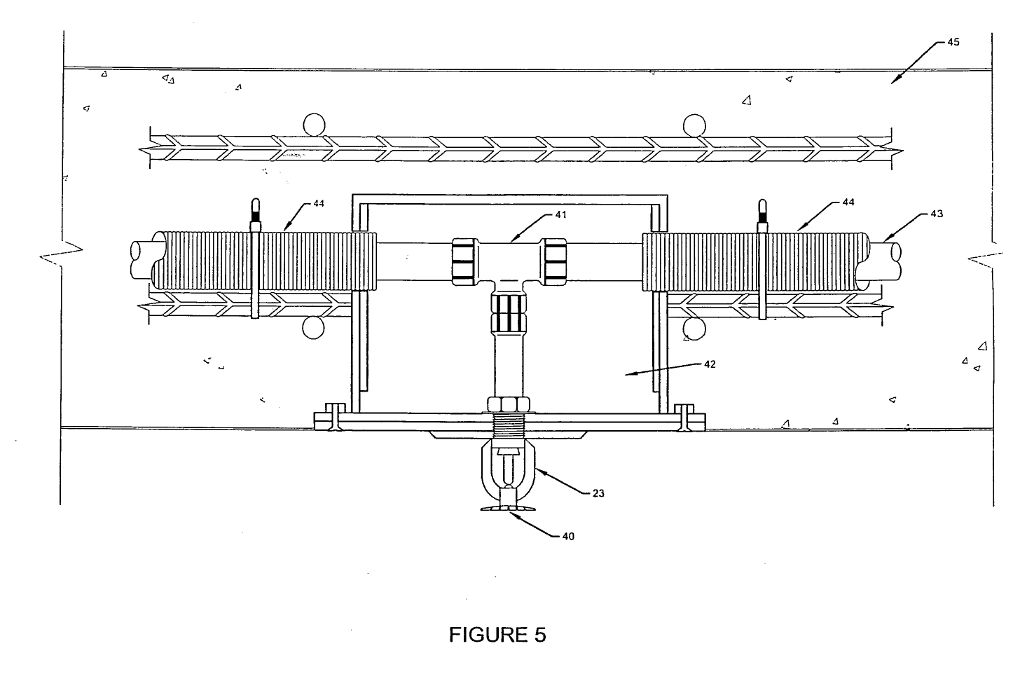

FIG. 5 shows a typical sprinkler 23 from FIG. 4 in vertical cross section. Each sprinkler is preferably also formed of standard components including a head 40 and a T-junction 41, located in a ceiling box 42. The ring main itself is preferably formed by an assembly of retrievable pipes 43 within sleeves 44 embedded in concrete 45.

Within each horizontal ring main, the sprinkler and domestic water supplies are combined in a single part of the overall network for the respective floor. Operation of a domestic fixture draws water through the respective ring main past the sprinklers and down the respective branch to the fixture. This prevents stagnation that would otherwise occur in a separate sprinkler system and effectively tests the sprinkler system on a daily basis.

Within each vertical ring main, the pipes supplying sprinklers, domestic supply and hydrants are combined as a single system over multiple floors. Operation of domestic fixtures within each vertical ring main draws water through the vertical pipe past the hydrants and again effectively tests the hydrant system and pump on a daily basis.

1. A water-supply system that provides integrated water services to a multi-story building, comprising:
at least one vertical pipe that supplies water to at least two floors of the multi-story building;
at least one hydrant at each floor connected to the at least one vertical pipe; and
a water-supply network at each floor connected to the vertical pipe, the network comprising:
a plurality of horizontal ring mains each supplying water to a respective one of a plurality of dwelling units on each floor;
at least one fire sprinkler connected to each of the plurality of horizontal rings mains; and
at least one vertical branch that connects at least one of the plurality of horizontal ring mains to at least one domestic plumbing fixture.

2. The water-supply system of claim 1, wherein the plurality of horizontal ring mains are connected to the at least one vertical pipe through a manifold.

3. The water-supply system of claim 1, further comprising a monitor for activating an alarm when the system is in a fire mode.

4. The water-supply system of claim 1, wherein the network further comprises at least one hose reel.

5. The water-supply system of claim 1, wherein operation of the at least one domestic plumbing fixture draws water from the at least one vertical pipe, around the at least one of the plurality of ring mains, and down the at least one vertical branch to the fixture.

6. A water-supply service for a multi-story building having a plurality of zones, comprising:
a plurality of water supply systems, each of the plurality of water supply systems supplying water to a corresponding one of the plurality of zones and comprising:
at least one vertical pipe that supplies water to floors located in the corresponding zone;
at least one hydrant connected to the at least one vertical pipe at each of the floors; and
a water-supply network connected to the vertical pipe at each of the floors, the network comprising:
a plurality of horizontal ring mains each supplying water to a respective one of a plurality of dwelling units on each floor;
at least one fire sprinkler connected to each of the plurality of horizontal rings mains; and
at least one vertical branch that connects at least one of the plurality of horizontal ring mains to at least one domestic plumbing fixture.
